(19) United States
(12) Patent Application Publication
(10) Pub. No.: US 2004/0090791 A1
(43) Pub. Date: May 13, 2004

(54) Rotating blind turn signal lamp

(75) Inventor: David L. Rhorer, Anderson, IN (US)

Correspondence Address: James D. Wood, ICE MILLER, One American Square, Box 82001, Indianapolis, IN, 46282-0002, US

(73) Assignee: GUIDE CORPORATION, Pendleton, IN

(21) Appl. No.: 10/289,837

(22) Filed: Nov. 7, 2002

(51) Int. Cl. F21V 17/02

(52) U.S. Cl. 362/512

(57) ABSTRACT

The present invention comprises a turn signaling system for use in a vehicle wherein a light source is intermittently occluded. The light source may be occluded by means of a mechanical or chemical shutter or by use of a rotating blind. According to one embodiment, the blind is shaped so as to create a pattern of light as the blind rotates.

### BACKGROUND OF THE INVENTION

The present invention relates generally to automotive lighting systems and, more specifically, to automotive turn signal lights.

The industry standard turn signal lamp assembly is comprised of a single bulb connected to a circuit which is switched on and off in an alternating fashion once the turn signal is engaged. This causes the bulb to alternately flash on and off. As turn signals are generally located toward the outer sides of a vehicle, the flashing of the turn signal indicates the direction in which the driver intends to turn.

While the above described turn signal system has been effective for a number of years, there are some drawbacks to the system. First, repeated cycling of the bulb on and off causes excess wear of the bulb filament, leading to premature failure of the bulb. Second, the standard turn signal system is used in the vast majority of vehicles. However, the automotive market is one wherein competitors attempt to distinguish themselves. Thus, a standard turn signal system does not assist in distinguishing a manufacturer's vehicle from a competitor's vehicle.

What is desired, therefore, is a turn signal system which does not result in premature failure of the turn signal bulb. It is further desired that the turn signal system provide a distinguishing feature as compared to standard turn signal systems, thereby providing manufacturers with a marketing edge.

### BRIEF SUMMARY OF THE INVENTION

In accordance with the present invention, a turn signal system comprises a light source which is continuously energized when a turn is being signaled, while the light emanating from the light source is intermittently occluded such that an observer sees a blinking light source. According to one embodiment, the light source is intermittently occluded by a blind which comprises at least one section penetrable by light and at least one section that is opaque. A blinking effect is produced by relative movement between the blind and the light source and/or reflector such that the bulb is intermittently occluded by the opaque section.

The present invention provides a turn signal system which does not result in premature failure of the turn signal bulb. Additionally, the present invention provides a distinguishing feature as compared to standard turn signal systems, thereby providing manufacturers with a marketing edge.

### BRIEF DESCRIPTION OF THE DRAWINGS

FIG. 1. is an exploded perspective view of a turn signal system according to the present invention.

FIG. 2A is a plan view of a reflector and light source for use in a turn signal system according to an alternative embodiment of the present invention.

FIG. 2B is a plan view of a rotating blind for use with the reflector and light source of FIG. 2A in a turn signal system according to an alternative embodiment of the present invention.

FIG. 3 is a side view of an alternative embodiment of the present invention incorporating an LCD blind.

### DETAILED DESCRIPTION OF THE INVENTION

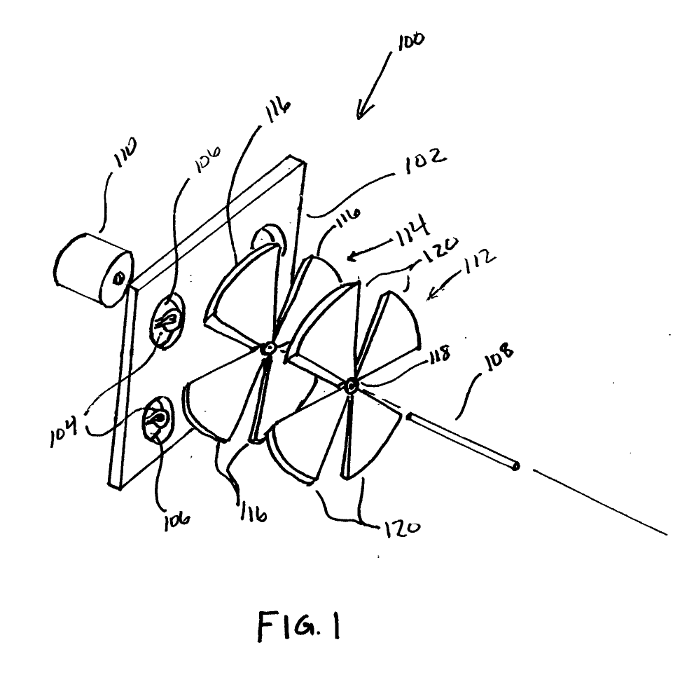

FIG. 1. is an exploded perspective view of a turn signal system according to the present invention. Turn signal assembly 100 includes base 102. Base 102 is formed so as to house light sources 104 which are inset into reflectors 106. Shaft 108 extends from motor 110 through base 102 and light shield 114 which is fixedly mounted upon base 102. Light shield 114 includes fins 116, which may be shaped or located so as to partially occlude light sources 104 and/or reflectors 106, or so as to not directly occlude light sources 104 and/or reflectors 106, such shape and location being a design choice based upon a number of considerations including the amount of light needed to be passes, and aesthetic look of the lamp. Blind 112 includes fins 120 and hub 118. Fins 120 are attached to hub 118. Blind 112 is rotatably mounted upon shaft 108 at hub 118.

In operation, when it is desired to indicate a turn, light sources 104 and motor 110 are energized according to methods well known in the art. Motor 110 serves as a means for moving shaft 108. As shaft 108 rotates, blind 112, which is appended to shaft 108 at hub 118, is caused to rotate. Blind 112 is fashioned in this embodiment such that when fins 120 of blind 112 are rotated to align with fins 116 of light shield 114, light from light sources 104 is allowed to pass by light shield 114 and blind 112. However, when blind 112 is further rotated so that fins 120 of blind 112 are not aligned with fins 116 of light shield 114, light from light sources 104 is occluded by light shield 114 and blind 112.

Those of skill in the art will understand that light shield 114 and blind 112 need not be designed to completely obscure the light emanating from light sources 104. In embodiments wherein the occlusion results in only partial obscuration, a pulsating turn signal may be realized. Moreover, although in the embodiment of FIG. 1, relative movement between the light source and the blind is rotational, those of skill in the relevant art will recognize that a means utilizing a linear displacement could be practiced within the scope of the present invention. Moreover, in certain applications it may be desired to reverse the position of light shield 114 and blind 112 relative to light sources 104, these alternative embodiments and others are within the scope of the present invention.

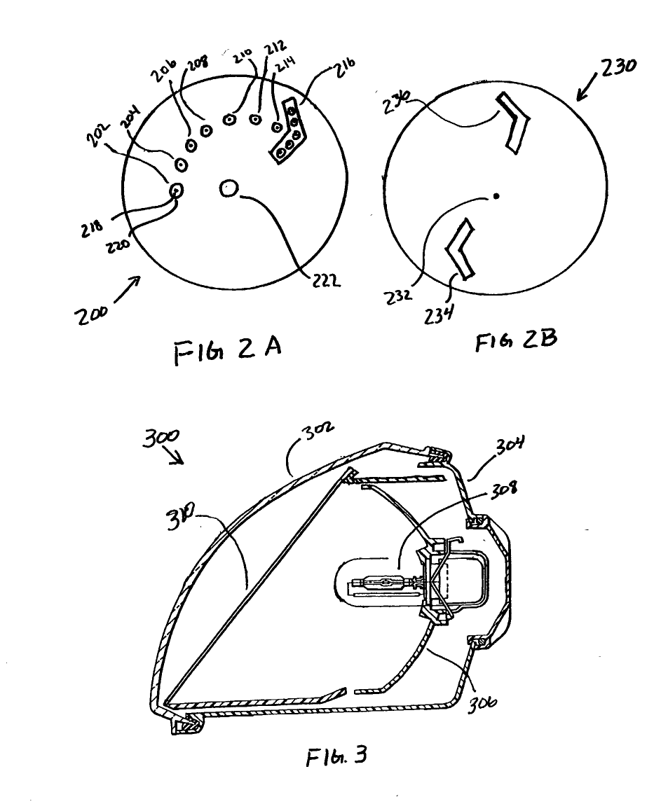

Referring now to FIG. 2A an alternative embodiment of the present invention is described. FIG. 2A is a plan view of reflector and light source for use in a turn signal system according to the present invention. Light mounting assembly 200 includes LED assemblies 202 through 216. Each of LED assemblies 202 through 214 includes an LED within a reflector cavity. For example, LED assembly 202 includes LED 218 and reflector 220. LED assemblies 216 includes a plurality of LEDs within reflector cavities. Light mounting assembly 200 also includes hole 222.

Referring now to FIG. 2B, a plan view of a rotating blind for use with the reflector and light source of FIG. 2A in a turn signal system according to an alternative embodiment of the present invention is shown. Rotating blind 230 includes hub 232 and cutouts 234 and 236. Hub 232 may be manufactured integrally with rotating blind 230 or may be manufactured separately. Rotating blind 230 in this embodiment serves as an appendage for intermittently occluding the light sources in FIG. 2a.

In operation, when it is desired to indicate a turn, LED assemblies 202 through 216 and a motor (not shown) are energized according to methods well known in the art. The motor, which may be mounted behind light mounting assembly 200 rotates a shaft (not shown) which passes through hole 222 and is operably connected to hub 232. Of course, the present invention is not limited by the location of the means for moving, which in this embodiment is a motor. For example, the means for moving could be mounted substantially at hole 222 between light mounting assembly 200 and blind 230 or at a location not physically connected to either light mounting assembly 200 or blind 230. The salient feature of the means for moving is that is be operably connected to either the light source and/or the reflector or the blind, so as to be capable of creating relative motion between the light source and/or the reflector or the blind.

Continuing with the description of operation of the embodiment of FIGS. 2A and 2B, as the shaft rotates, blind 230 is rotated. In this example, blind 230 is rotated in a clockwise direction, although a counter-clockwise direction may be used. As cutouts 234 and 236 pass over LED assemblies 202 through 216, the light emanating from LED assemblies 202 through 216 and their associated reflectors is not occluded. Accordingly, a viewer observes, in sequence, LED assemblies 202 through 216. The embodiment of FIGS. 2A and 2B is designed such that as cutout 236 passes over LED assembly 216, cutout 234 is approaching LED assembly 202. Thus, to a viewer, it would appear as if LED assembly 202 is energized shortly after LED assembly 216 is de-energized.

Referring to FIG. 3, an alternative embodiment of the present invention is shown which does not utilize a motor. Turn signal assembly 300 includes lens 302 connected to housing 304. Reflector 306 light source 308, and liquid crystal panel (LCP) 310 are mounted within housing 304. LCP 310 is sized such that any light emanating from turn signal assembly 300 must pass through LCP 310.

As is well known, liquid crystal devices (LCD) consist of a sheet of oriented particles contained between two layers of glass or plastic. When an electric signal is applied to the LCD, the signal renders the entire sheet clear or opaque, as desired. With respect to LCP 310, the entire panel is simultaneously completely opaque or completely clear. In operation, when it is desired to indicate a turn, light source 308 is energized. Then, an electric signal is intermittently applied to and removed from LCP 310. Accordingly, light from light source 308 is intermittently allowed to pass through LCP 310 and intermittently occluded from passing through LCP 310.

Those of skill in the art will recognize that a turn signal system according to the present invention does not result in premature failure of the turn signal bulb. Moreover, the present invention provides a distinguishing feature as compared to standard turn signal systems, thereby providing manufacturers with a marketing edge.

While the present invention has been described in detail with reference to certain exemplary embodiments thereof, such are offered by way of non-limiting example of the invention, as other versions are possible. Those of skill in the art will recognize that a variety of light sources and blinds may be used in practicing the present invention. By way of example, but not of limitation, it may be desired to fashion the light assembly with filament bulbs or LEDs. Moreover, the present invention may be practiced with a variety of motors to cause relative motion between the blind and the light source and/or reflector, or with no motor at all. Finally, the light emanating from the turn signal assembly need not be totally occluded. The salient characteristic, is that the light emanating from the turn signal assembly vary in intensity, so as to provide the function of a turn signal. It is anticipated that a variety of other modifications and changes will be apparent to those having ordinary skill in the art and that such modifications and changes are intended to be encompassed within the spirit and scope of the invention as defined by the following claims.

We claim:

1. A turn signaling device for use in a vehicle for signaling a turn comprising:
a light source, and
means for intermittently occluding the light source, such that when a turn is being signaled, the light source is energized, and light emanating from the light source is intermittently occluded to cause a blinking effect.

2. The turn signaling device of claim 1, wherein the means for intermittently occluding the light source comprises,
an appendage comprising at least one section capable of occluding light and movable relative to the light source between a first and a second position, such that when the appendage is in the first position, light emanating from the light source is occluded and when the appendage is in the second position, light emanating from the light source is less occluded, and
means for moving the appendage between the first and second position, the means for moving operably connected to the appendage.

3. The turn signaling device of claim 2, wherein the appendage comprises
a shaft, rotatable about an axis, and
a hub operably connected to the shaft and operably connected to the one section capable of occluding light such that when the shaft is rotated about the axis, the one section capable of occluding light is rotated between the first and second position.

4. The turn signaling device of claim 1, wherein the means for intermittently obscuring the light source comprises,
a liquid crystal blind having a first state wherein the liquid crystal blind is substantially transparent and a second state wherein the liquid crystal blind occludes the light source, and
a control circuit operably connected to the liquid crystal blind for switching the liquid crystal blind between the first state and the second state.

5. A method of signaling a turn by a vehicle comprising the steps of
illuminating a light source, and
intermittently occluding the light emanating from the light source.

6. The method of claim 5, wherein the step of intermittently occluding the light source further comprises the steps of
placing an appendage comprising at least one section capable of occluding light and movable relative to the light source in a first position wherein light emanating from the light source is occluded and
placing the appendage in a second position wherein light emanating from the light source is less occluded.

7. The method of claim 6 wherein
the step of placing the appendage in a first position comprises the step of rotating to a first position a shaft operably connected to a hub which is in turn operably connected to the at least one section capable of occluding light, such that when the shaft is rotated to the first position, the hub is moved and in turn the at least one section capable of occluding light is moved to its first position, and wherein
the step of placing the appendage in a second position comprises the step of rotating to a second position a shaft operably connected to a hub which is in turn operably connected to the at least one section capable of occluding light, such that when the shaft is rotated to the second position, the hub is moved and in turn the at least one section capable of occluding light is moved to its second position.

8. The method of claim 5 wherein the step of intermittently occluding the light source further comprises the steps of
switching a liquid crystal blind having a first state wherein the liquid crystal blind is substantially transparent and a second state wherein the liquid crystal blind occludes the light source to one of the two states, and
switching the liquid crystal blind to the other of the two states.

9. A turn signaling device for use in a vehicle for signaling a turn comprising:
a light source,
a first appendage comprising at least one section capable of occluding light from the light source and at least one section less capable of occluding light from the light source,
a second appendage comprising at least one section capable of occluding light and movable relative to the light source and the first appendage between a first and a second position, such that when the second appendage is in the first position, the at least one section capable of occluding light of the second appendage is positioned relative to the at least one section less capable of occluding light of the first appendage such that light emanating from the light source is occluded by the first and the second appendage and when the second appendage is in the second position, the at least one section capable of occluding light of the second appendage is positioned relative to the at least one section less capable of occluding light of the first appendage such that light emanating from the light source is less occluded by the first and the second appendage,
a hub operably connected to the second appendage such that when the shaft is rotated about the axis, the one section of the second appendage is rotated between the first and second position, and
a shaft, operably connected to the hub and rotatable about an axis between a first and a second position, such that as the shaft is rotated between the first and second position, the one section of the second appendage is rotated between the first and second position.
